(19) United States
(12) Patent Application Publication
(10) Pub. No.: US 2012/0008046 A1
(43) Pub. Date: Jan. 12, 2012

(54) HORIZONTAL SYNCHRONIZATION GENERATION CIRCUIT, VIDEO SIGNAL PROCESSING LSI, AND VIDEO SYSTEM

(75) Inventors: Masayuki Fukuyama, Osaka (JP); Kunihiro Kaida, Osaka (JP)

(73) Assignee: PANASONIC CORPORATION, Osaka (JP)

(21) Appl. No.: 13/240,625

(22) Filed: Sep. 22, 2011

Related U.S. Application Data
(63) Continuation of application No. PCT/JP2010/000716, filed on Feb. 5, 2010.

(30) Foreign Application Priority Data
Apr. 3, 2009 (JP) 2009-091044

(51) Int. Cl. H04N 5/06

(52) U.S. Cl. 348/524; 348/E05.011

(57) ABSTRACT

A horizontal synchronization generation circuit, which generates a horizontal synchronizing signal from a given reference clock, enables accurate reproduction of a preferable frame frequency with a simple configuration. A clock counter counts the reference clock. A comparator generates the horizontal synchronizing signal at a time when a count value output from the clock counter becomes equal to a synchronization counter value. A synchronization counter value output section generates the synchronization counter value by performing addition/subtraction in each of scanning lines based on a basic counter value.

### CROSS-REFERENCE TO RELATED APPLICATION

This is a continuation of PCT International Application PCT/JP2010/000716 filed on Feb. 5, 2010, which claims priority to Japanese Patent Application No. 2009-091044 filed on Apr. 3, 2009. The disclosures of these applications including the specifications, the drawings, and the claims are hereby incorporated by reference in their entirety.

### BACKGROUND

The present disclosure relates to techniques for generating horizontal synchronizing signals used for image display.

In recent video systems, video signals such as high-definition signals etc. which have various formats need to be converted to signals corresponding to a display panel. Then, generating a horizontal synchronizing signal with an accurate frequency, and accurately reproducing a preferable frame frequency following a format are extremely important in view of image quality.

Japanese Patent Publication No. H07-312699 shows a technique of generating a horizontal synchronizing signal by dividing the frequency of a clock for pixel sampling when converting a high-definition signal to a signal which can be played with an NTSC monitor.

### SUMMARY

Japanese Patent Publication No. H07-312699 teaches selecting an integer near the numerical value obtained by the following expression as a dividing ratio for generating a horizontal synchronizing signal.

(Clock frequency)÷(frame frequency)÷(the number of scanning lines)

In this case, a horizontal synchronization frequency is always the value higher or lower than the original frequency. Thus, a frame frequency obtained from the horizontal synchronization frequency, which is not exactly accurate, is also inaccurate. That is, a preferable frame frequency following a video format cannot be accurately reproduced. In Japanese Patent Publication No. H07-312699, the phase of a horizontal synchronizing signal is matched by initializing a programmable frequency divider during a vertical synchronization period. However, the horizontal synchronization frequency is not exactly accurate. Therefore, the problem that a preferable frame frequency cannot be accurately reproduced is unsolved.

It is an objective of the present disclosure to enable accurate reproduction of a preferable frame frequency with a simple configuration in a horizontal synchronization generation circuit generating a horizontal synchronizing signal from a reference clock.

The present disclosure provides a horizontal synchronization generation circuit configured to generate a horizontal synchronizing signal from a given reference clock. The horizontal synchronization generation circuit includes a clock counter configured to count the reference clock; a synchronization counter value output section configured to output a synchronization counter value for generating the horizontal synchronizing signal; and a comparator configured to generate the horizontal synchronizing signal at a time when a count value output from the clock counter becomes equal to the synchronization counter value. The synchronization counter value output section generates the synchronization counter value by performing addition/subtraction in each of scanning lines based on a basic counter value.

According to the present disclosure, the synchronization counter value configured to generate the horizontal synchronizing signal by performing addition/subtraction in each of the scanning lines based on the basic counter value. This controls the horizontal synchronization frequency in each of the scanning lines, and thus a preferable frame frequency following a video format can be accurately reproduced.

According to the present disclosure, a horizontal synchronization frequency is controlled in each of scanning lines, and thus, a preferable frame frequency following the video format can be accurately reproduced.

### BRIEF DESCRIPTION OF THE DRAWINGS

FIG. 1 illustrates the configuration of a horizontal synchronization generation circuit according to an embodiment.

FIG. 2 illustrates a video signal processing LSI including the horizontal synchronization generation circuit according to the embodiment.

FIG. 3 illustrates an example of mounting the horizontal synchronization generation circuit according to the embodiment.

### DETAILED DESCRIPTION

An embodiment of the present disclosure will be described hereinafter with reference to the drawings.

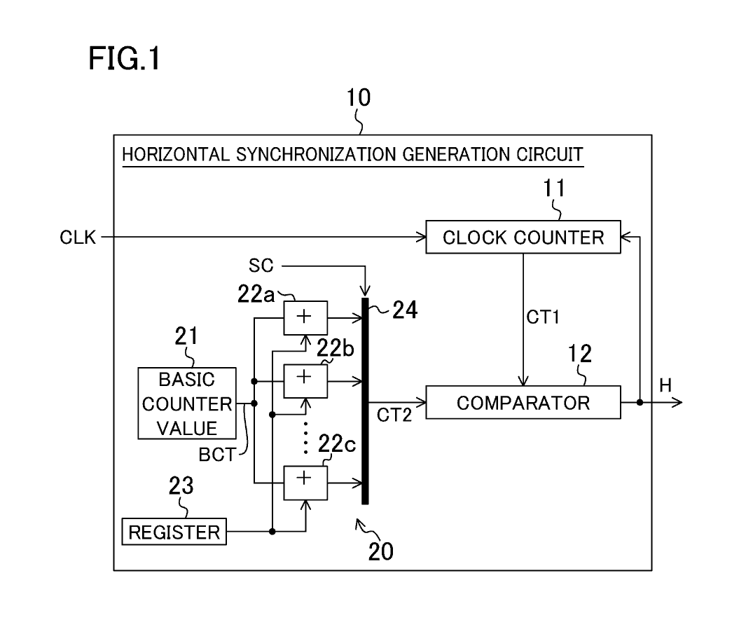

FIG. 1 illustrates the configuration of a horizontal synchronization generation circuit according to an embodiment. A horizontal synchronization generation circuit 10 shown in FIG. 1 generates a horizontal synchronizing signal H from a given reference clock CLK. In the horizontal synchronization generation circuit 10, a clock counter 11 counts the reference clock CLK, and outputs the count value CT1. A synchronization counter value output section 20 outputs a synchronization counter value CT2 for generating the horizontal synchronizing signal H. The comparator 12 compares the counter value CT1 output from the clock counter 11 to the synchronization counter value CT2 output from the synchronization counter value output section 20, and generates the horizontal synchronizing signal H at the time when the counter value CT1 becomes equal to the synchronization counter value CT2. That is, the synchronization counter value CT2 determines a horizontal synchronization frequency. The clock counter 11 is reset once the horizontal synchronizing signal H is output.

The synchronization counter value output section 20 performs addition/subtraction in each of scanning lines based on a basic counter value BCT to generate the synchronization counter value CT2. Specifically, the synchronization counter value output section 20 includes a setting section 21 setting the basic counter value BCT, a plurality of adder/subtractors 22a, 22b, . . . , 22c performing addition/subtraction on the basic counter value BCT output from the setting section 21, a register 23 at which an operation value used for the addition/subtraction is individually set in each of the adder/subtractors 22a, 22b, . . . , 22c, and a selector 24 selecting one of outputs of the adder/subtractors 22a, 22b, . . . , 22c as the synchronization counter value CT2 and outputting the selected value. The selector 24 switches among the adder/subtractor 22a, 22b, . . . , 22c to be selected in accordance with an instruction signal SC indicating a scanning line. The instruction signal SC may be generated by, for example, a counter counting the horizontal synchronizing signal H. This configuration enables repetition of the same addition/subtraction using a predetermined number of scanning lines as a unit.

Operation of the horizontal synchronization generation circuit of FIG. 1 will be described in detail using a top field of 1080i format as an example. In this example, the frequency of the reference clock CLK is 27 MHz.

In a conventional specification, the frame frequency is 59.940 (=60/1.001) MHz, the operating frequency (clock frequency) is 74.176 (=74.25/1.001) MHz, and the pixel number per line is 2200 pixels. At this time, where the reference clock frequency is 27 MHz, the pixel number per line is as follows.

$$\begin{matrix}2200 / ( 74.25 / 1.001 ) \times 27 = 800 \times 1.001 \\ = 800.8 pixels\end{matrix}$$

Note that the reference clock frequency of 27 MHz is not equal to the integer multiple of the product of a frame frequency and the number of scanning lines.

Therefore, when the synchronization counter value CT2 is set to integer 4004 (=800.8×5) as the sum of five scanning lines, an accurate horizontal synchronization frequency can be obtained. Thus, for example, five adders are provided as adder/subtractors 22a, 22b, . . . , 22c, and the basic counter value BCT is set to 800. Then, “+1,” “+1,” “0,” “+1,” and “+1,” are set at the register 23 as operation values of the adders. The synchronization counter value CT2 is thus the repetition of “801,” “801,” “800,” “801,” and “801.” As a result, when viewing a single scanning line, an accurate horizontal synchronization frequency is not exactly obtained. However, an accurate horizontal synchronization frequency is obtained in units of five scanning lines. Therefore, a preferable frame frequency is accurately reproduced.

Even in a case other than the top field of 1080i format, a preferable frame frequency can be accurately reproduced in a manner similar to that of the above.

While in this embodiment, “+1” and “0” are set as operation values using the adders, “0” and “−1” may be set as operation values using subtractors. Alternately, “+1,” “0” and “−1” may be set as operation values using adder/subtractors. Also, the range of the operation values may be extended to, e.g., “+3,” “+2,” “+1,” and “0.” Note that the difference of the horizontal synchronization frequency in each of the scanning lines is preferably small, and thus, the range of the operation values is preferably narrow.

While in this embodiment, the number of the adder/subtractors 22a, 22b, . . . , 22c is five, the number is not limited thereto. In view of accuracy of a horizontal synchronization frequency which is actually needed and the circuit scale of the horizontal synchronization generation circuit 10, the number of adder/subtractors 22a, 22b, . . . , 22c is preferably five or less, but may be clearly more than five. For example, although it is not realistic in implementing, adder/subtractors in the number corresponding to all the scanning lines may be provided.

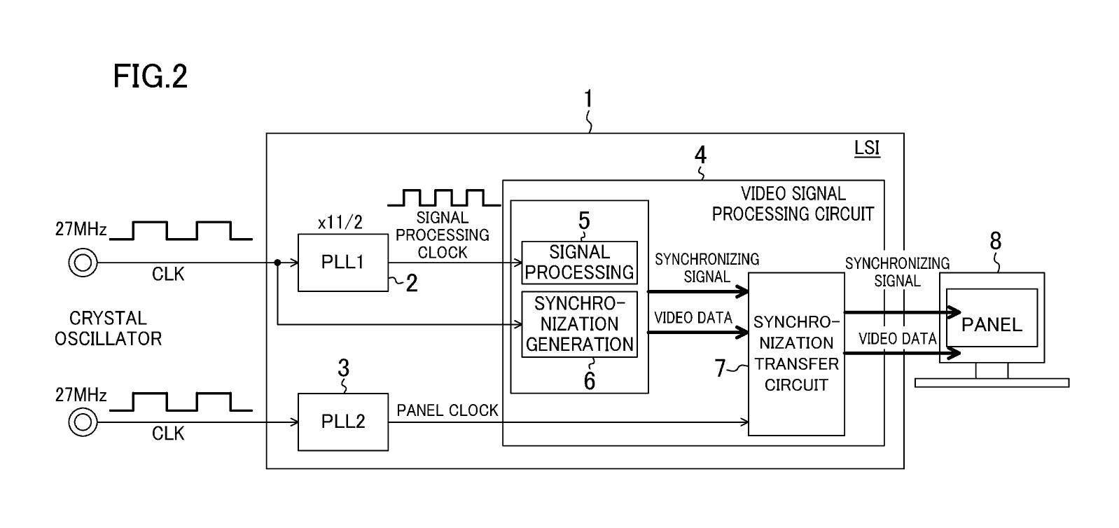

FIG. 2 illustrates an example of the main configuration of a video signal processing LSI including the horizontal synchronization generation circuit according to this embodiment. A video signal processing LSI 1 of FIG. 2 includes a PLL circuit 2 generating a signal processing clock from a reference clock CLK generated by a crystal oscillator, a PLL circuit 3 generating a panel clock from the reference clock CLK, and a video signal processing circuit 4 for generating video data to be output to a panel 8. The video signal processing circuit 4 includes a signal processing section 5 performing signal processing in response to the signal processing clock, a synchronization generation section 6 generating a synchronizing signal in response to the reference clock CLK, and a synchronization transfer circuit 7 synchronizingly transferring video data to a panel clock. The above-described horizontal synchronization generation circuit is included in the synchronization generation section 6.

In a conventional video signal processing LSI, a synchronizing signal has been generally generated from a signal processing clock. In this case, when the frequency of the signal processing clock is not an integer multiple of (frame frequency)×(the number of scanning lines), an accurate synchronizing signal cannot be generated. Thus, the frequency of the signal processing clock needs to be changed in accordance with the video format. For example, an NTSC system requires clocks of 148.5 MHz (frame frequency 50/60 Hz) and 148.35 MHz (for high definition: frame frequency 60/1.001 Hz). In this case, where the reference clock CLK is 27 MHz, a PLL circuit with a high multiplication factor such as 1012/184 or 1000/182 needs to be provided. In a PLL circuit, when the multiplication factor is high, the circuit area increases, and jitter performance against fluctuations of a clock is difficult to guarantee.

On the other hand, in the video signal processing LSI 1 of FIG. 2, a synchronizing signal is generated not from a signal processing clock but from an original reference clock CLK. Thus, the frequency of the signal processing clock is always constant, and there is no need to provide a PLL circuit with a high multiplication factor. For example, in order to maintain the signal processing clock at 148.5 MHz, the multiplication factor of the PLL circuit 2 may be so low as 11/2. This largely reduces the circuit area of the PLL circuit and improves jitter performance.

Note that the video signal processing LSI according to this embodiment is built in various video systems and used. The video systems are for example, a TV system, a car navigation system, a DVD recorder/player, a Blu-ray recorder/player, a portable video player, etc.

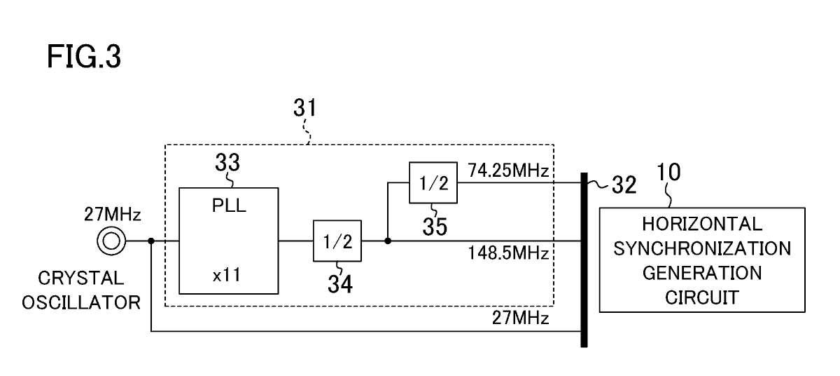

FIG. 3 illustrates an example configuration of mounting the horizontal synchronization generation circuit according to this embodiment. In the configuration of FIG. 3, a clock change circuit 31 and a selector 32 are provided in a stage prior to the horizontal synchronization generation circuit 10 as shown in FIG. 1 to select a reference clock given to the horizontal synchronization generation circuit 10 from an original clock of 27 MHz, and clocks of 148.5 MHz and 74.25 MHz, which are converted from the original 27 MHz clock. The clock change circuit 31 includes a PLL circuit 33 with a multiplication factor of 11, and two frequency dividers 34 and 35.

From the configuration of FIG. 3, clocks of a plurality of frequencies are available as a reference clock which is a basis of generating a horizontal synchronizing signal, and thus, the horizontal synchronization generation circuit 10 can follow more video formats. Note that, as can be seen from the configuration of FIG. 1, when the addition/subtraction is stopped by, for example, setting all the values at the register 23 “0,” the synchronization counter value CT2 is fixed, and the horizontal synchronization frequency is constant in each of the scanning lines. That is, in the configuration of FIG. 1, the horizontal synchronization frequency can be changed in each of the scanning lines, and the horizontal synchronization frequency can be constant in each of the scanning lines.

In the horizontal synchronization generation circuit according to the present disclosure, a preferable frame frequency following the video format can be accurately reproduced. Therefore, the horizontal synchronization generation circuit according to the present disclosure is, e.g., advantageous in improving image quality of a TV system displaying high-definition video.

What is claimed is:

1. A horizontal synchronization generation circuit configured to generate a horizontal synchronizing signal from a given reference clock, the horizontal synchronization generation circuit comprising:
a clock counter configured to count the reference clock;
a synchronization counter value output section configured to output a synchronization counter value for generating the horizontal synchronizing signal; and
a comparator configured to generate the horizontal synchronizing signal at a time when a count value output from the clock counter becomes equal to the synchronization counter value, wherein
the synchronization counter value output section generates the synchronization counter value by performing addition/subtraction in each of scanning lines based on a basic counter value.

2. The horizontal synchronization generation circuit of claim 1, wherein
the synchronization counter value output section repeats same addition/subtraction using a predetermined number of scanning lines as a unit.

3. The horizontal synchronization generation circuit of claim 1, wherein
the synchronization counter value output section includes
a setting section configured to set the basic counter value,
a plurality of adder/subtractors each configured to perform addition/subtraction on the basic counter value output from the setting section,
a register at which an operation value used for the addition/subtraction is individually set for each of the adder/subtractors, and
a selector configured to select and output one of outputs of the plurality of adder/subtractors as the synchronization counter value in accordance with an instruction signal indicating a scanning line.

4. The horizontal synchronization generation circuit of claim 3, wherein
the adder/subtractor is an adder, and
zero or one is set at the register as the operation value.

5. The horizontal synchronization generation circuit of claim 3, wherein
the number of the plurality of adder/subtractors is five or less.

6. The horizontal synchronization generation circuit of claim 1, wherein
the reference clock has a frequency which is unequal to an integer multiple of a product of a frame frequency and the number of scanning lines.

7. A video signal processing LSI comprising:
the horizontal synchronization generation circuit of claim 1; and
a PLL circuit configured to generate a signal processing clock from the reference clock.

8. A video system comprising the video signal processing LSI of claim 7.
